(19) United States
(12) Patent Application Publication
(10) Pub. No.: US 2019/0140754 A1
(43) Pub. Date: May 9, 2019

(54) INFORMATION PROCESSING APPARATUS AND CONTROL METHOD BY THE SAME

(71) Applicant: TOSHIBA TEC KABUSHIKI KAISHA, Tokyo (JP)

(72) Inventor: Shinichi Shimoirisa, Mishima Shizuoka (JP)

(21) Appl. No.: 16/181,394

(22) Filed: Nov. 6, 2018

(30) Foreign Application Priority Data
Nov. 6, 2017 (JP) 2017-214034

(51) Int. Cl. H04B 17/318; H04W 24/08; G06K 7/10

(52) U.S. Cl. CPC H04B 17/318; G06K 7/10366; H04W 24/08

(57) ABSTRACT

An information processing apparatus comprises a wireless communication module which establishes wireless communication with an external device; a radio field intensity measurement module; a radio field intensity display module; and a display control module. The display control module determines whether the radio field intensity tends to increase or decrease based on the measurement result of the radio field intensity by the radio field intensity measurement module, and updates the radio field intensity display to a display indicating a stronger radio field intensity if the radio field intensity tends to increase and the radio field intensity is equal to or larger than a first threshold value, or updates the radio field intensity display to a display indicating a weaker radio field intensity if the radio field intensity tends to decrease and the radio field intensity is less than a second threshold value smaller than the first threshold value.

### CROSS-REFERENCE TO RELATED APPLICATION

This application is based upon and claims the benefit of priority from Japanese Patent Application No. 2017-214034, filed Nov. 6, 2017, the entire contents of which are incorporated herein by reference.

### FIELD

Embodiments described herein relate generally to an information processing apparatus and a control method by the same.

### BACKGROUND

For example, in a shop such as a retail store, a commodity data processing apparatus for inputting a commodity to be purchased is used. A settlement terminal wirelessly connected with the commodity data processing apparatus is used as well.

The settlement terminal receives a settlement amount from the commodity data processing apparatus, reads card information from a card (e.g., a credit card) possessed by a customer, and performs a settlement processing for instructing a server (e.g., a center server of a credit card company) to perform settlement based on the settlement amount and the card information.

In the above configuration, the settlement terminal successively measures a radio field intensity and displays a radio field intensity display indicating the radio field intensity. In order to efficiently perform wireless communication between the settlement terminal and the commodity data processing apparatus, an operator needs to adjust a positional relationship between the settlement terminal and the commodity data processing apparatus while confirming the radio field intensity display.

In the settlement terminal, since a processing to be executed is limited when compared with the commodity data processing apparatus, a processor having lower processing performance than that of the commodity data processing apparatus is mainly used. However, there is a problem that a processing of frequently updating the radio field intensity display becomes a burden for the processor having low processing performance.

### DESCRIPTION OF THE DRAWINGS

FIG. 1 is a diagram illustrating an example of a configuration of a settlement system according to an embodiment;

FIG. 2 is a diagram illustrating an example of a configuration of a commodity data processing apparatus according to the embodiment;

FIG. 3 is a diagram illustrating an example of a configuration of a settlement terminal according to the embodiment;

FIG. 4 is a diagram illustrating an example of an operation performed by the settlement terminal according to the embodiment; and

FIG. 5 is a diagram illustrating an example of an operation performed by the settlement terminal according to the embodiment.

### DETAILED DESCRIPTION

In accordance with an embodiment, an information processing apparatus comprises a wireless communication module configured to establish wireless communication with an external device; a radio field intensity measurement module configured to measure a radio field intensity used in the wireless communication; a radio field intensity display module configured to display a radio field intensity display indicating the radio field intensity, and a display control module. The display control module determines whether the radio field intensity tends to increase or decrease based on the measurement result of the radio field intensity by the radio field intensity measurement module, and updates the radio field intensity display to a display indicating a stronger radio field intensity if the radio field intensity tends to increase and the radio field intensity is equal to or larger than a first threshold value, or updates the radio field intensity display to a display indicating a weaker radio field intensity if the radio field intensity tends to decrease and the radio field intensity is less than a second threshold value smaller than the first threshold value.

Hereinafter, an information processing apparatus and a control method by the same according to an embodiment are described with reference to the accompanying drawings.

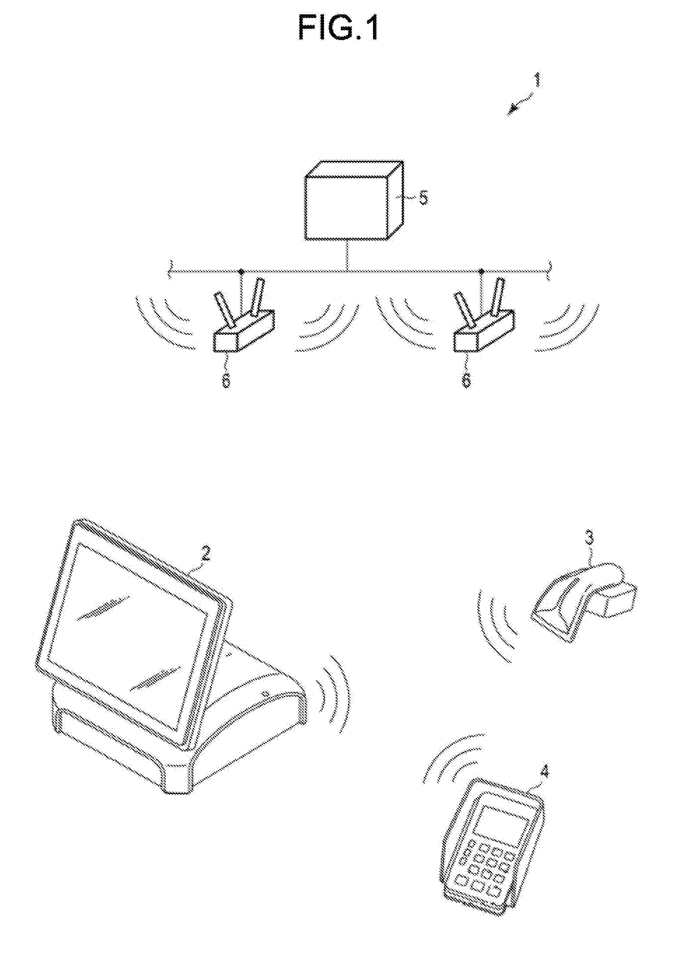

FIG. 1 is a diagram illustrating an example of a configuration of a settlement system 1 according to the embodiment. The settlement system 1 performs settlement of a price (settlement amount) of a commodity purchased by a customer in a shop such as a retail store. The settlement system 1 comprises a commodity data processing apparatus 2, a scanner 3, a settlement terminal 4 and a settlement server 5. The commodity data processing apparatus 2 and the settlement server 5 are installed in a shop and can communicate with each other via an access point 6 that relays wireless communication.

First, a configuration of the commodity data processing apparatus 2 is described.

The commodity data processing apparatus 2 acquires information (commodity identification information) for identifying a commodity to generate a list of commodities to be purchased by a customer. The commodity data processing apparatus 2 is, for example, a POS (Point Of Sales) terminal in which a store clerk in a retail store uses the scanner 3 to read the commodity identification information of the commodity.

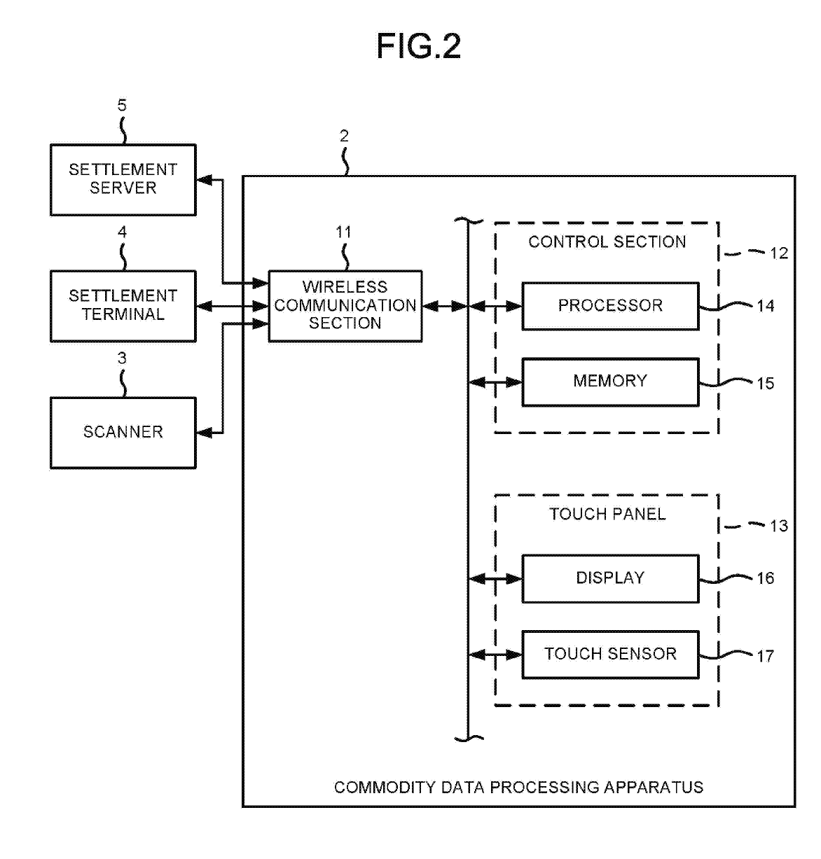

FIG. 2 is a diagram illustrating an example of a configuration of the commodity data processing apparatus 2. The commodity data processing apparatus 2 comprises a wireless communication section 11, a control section 12, and a touch panel 13.

The wireless communication section 11 is an interface for the commodity data processing apparatus 2 to communicate with other devices. The wireless communication section 11 includes a circuit for the commodity data processing apparatus 2 to communicate with the scanner 3, the settlement terminal 4, and the settlement server 5 by wireless communication of a predetermined frequency. The wireless communication section 11 communicates with the scanner 3, the settlement terminal 4, and the settlement server 5 under the control of the control section 12. The wireless communication section 11 communicates with the scanner 3 to acquire commodity identification information for identifying a commodity from the scanner 3. The commodity data processing apparatus 2 may have a communication interface for communicating with the settlement server 5 and the scanner 3 in a wired manner.

The scanner 3 reads the commodity identification information for identifying a commodity. For example, the scanner 3 reads a code (for example, a barcode, a two-dimensional code, or other codes) assigned to a commodity, for example, by printing. The scanner 3 decodes the read code to acquire the commodity identification information. The scanner 3 transmits the acquired commodity identification information to the commodity data processing apparatus 2.

The control section 12 executes various processing. The control section 12 comprises a processor 14 and a memory 15.

The processor 14 is an arithmetic element for executing an arithmetic processing. For example, the processor 14 is a CPU (Central Processing Unit). The processor 14 performs various processing by executing programs stored in the memory 15.

The memory 15 stores programs and data. For example, the memory 15 includes one or more of a ROM which is a read-only nonvolatile memory, a RAM which temporarily stores data, and a storage which stores data.

The touch panel 13 displays a screen and generates an operation signal based on an operation performed by a customer. The touch panel 13 includes a display 16 and a touch sensor 17.

The display 16 displays a screen based on display data (screen data) supplied from the control section 12 or a graphic controller (not shown).

The touch sensor 17 generates an operation signal indicating a position touched by an operator who operates the commodity data processing apparatus 2 on the screen displayed on the display 16.

The commodity data processing apparatus 2 may include an operation section for generating an operation signal based on the operation. The operation section may include operation keys for instructing the commodity data processing apparatus 2 to execute various operations and numeric keys for inputting an amount or numbers to the commodity data processing apparatus 2.

The processor 14 executes the program stored in the memory 15, and in this way, the control section 12 of the commodity data processing apparatus 2 executes a commodity input processing. The commodity input processing is to generate a list of commodities purchased by a customer based on the commodity identification information acquired from the scanner 3 and to calculate a settlement amount to be settled. The settlement amount is a sum of the amount of the commodities purchased by the customer.

The control section 12 determines a settlement method based on an operation input to the touch panel, for example. The settlement methods include, for example, a cash settlement, a credit settlement, and the like. If the cash settlement is selected, the control section 12 performs a processing for settling the settlement amount using cash. If the credit settlement is selected, the control section 12 transmits the settlement amount to the settlement terminal 4 to enable the settlement terminal 4 to execute the credit settlement using a credit card.

Next, the configuration of the settlement terminal 4 is described.

The settlement terminal 4 receives the settlement amount from the commodity data processing apparatus 2, reads card information from a card (e.g., a credit card) possessed by the customer, and executes a credit settlement for requesting a server (e.g., a center server of a credit card company) for a settlement based on the settlement amount and the card information.

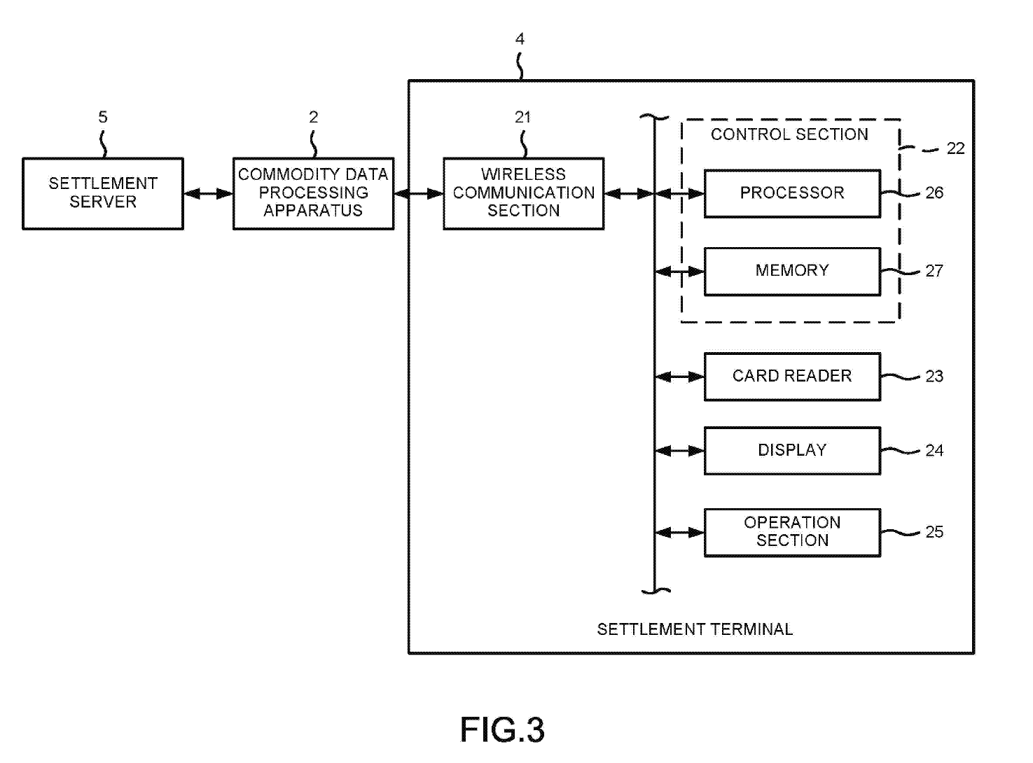

FIG. 3 is a diagram illustrating an example of a configuration of the settlement terminal 4. The settlement terminal 4 comprises a wireless communication section 21, a control section 22, a card reader 23, a display 24, and an operation section 25.

The wireless communication section 21 is used for the settlement terminal 4 to communicate with the commodity data processing apparatus 2. The wireless communication section 21 includes a circuit for the settlement terminal 4 to communicate with the commodity data processing apparatus 2 by wireless communication of a predetermined frequency. The wireless communication section 21 communicates with the commodity data processing apparatus 2 under the control of the control section 22. The wireless communication section 21 communicates with the commodity data processing apparatus 2 to acquire the settlement amount from the commodity data processing apparatus 2.

The control section 22 executes various processing. The control section 22 comprises a processor 26 and a memory 27.

The processor 26 is an arithmetic element for executing an arithmetic processing. The processor 26 is, for example, a CPU. The processor 26 performs various processing by executing programs stored in the memory 27. The processing to be executed by the processor 26 of the settlement terminal 4 is limited when compared with the processor 14 of the commodity data processing apparatus 2. Therefore, the processor 26 has lower processing performance than the processor 14. Specifically, the processor 26 has a lower operating frequency, a lower IPC (Instructions Per Clock cycle), a less number of cores, a smaller cache and register, etc., when compared with the processor 14.

The memory 27 stores programs and data. For example, the memory 27 includes one or more of a ROM which is a read-only nonvolatile memory, a RAM which temporarily stores data, and a storage which stores data.

The card reader 23 reads information from the credit card possessed by the customer. For example, the card reader 23 has a slot through which a credit card is inserted and a communication circuit for communicating with a credit card inserted through the slot. The card reader 23 supplies power to the credit card to transmit and receive information to and from the credit card.

The display 24 displays a screen based on the display data (screen data) supplied from the control section 22.

The operation section 25 generates an operation signal based on an operation. The operation section 25 has an operation key for a customer to input a personal identification number, an operation key for selecting the number of times of payment in the credit settlement, and the like.

Next, a flow of the credit settlement performed in the commodity data processing apparatus 2 and the settlement terminal 4 is described. The processor 26 executes a program stored in the memory 27, and in this way, the control section 22 of the settlement terminal 4 executes the credit settlement.

As described above, when the credit settlement is selected in the commodity data processing apparatus 2, the commodity data processing apparatus 2 transmits the settlement amount to the settlement terminal 4 by wireless communication.

The control section 22 of the settlement terminal 4 acquires the settlement amount transmitted from the commodity data processing apparatus 2 through the wireless communication section 21. In this case, a store clerk operating the commodity data processing apparatus 2 guides the customer to insert a credit card into the slot of the card reader 23 of the settlement terminal 4.

The control section 22 of the settlement terminal 4 transmits a command for reading the card information from the credit card inserted into the slot of the card reader 23. The control section 22 acquires the card information in response to the command. Specifically, the control section 22 and the card reader 23 function as a card reading module for reading the card information from the card possessed by the customer.

The control section 22 of the settlement terminal 4 generates a settlement request in which the settlement amount is associated with the card information. The control section 22 transmits the settlement request to the settlement server 5 via the commodity data processing apparatus 2. Specifically, the control section 22 functions as a settlement processing module that acquires the settlement amount of the commodity from the commodity data processing apparatus 2 and performs the settlement processing based on the settlement amount and the card information.

The settlement server 5 is a server of a credit card company. When the settlement server 5 receives the settlement request from the settlement terminal 4, the settlement server 5 determines whether to approve the settlement based on the settlement request, and transmits either approval or disapproval as a response to the settlement terminal 4.

The control section 22 of the settlement terminal 4 transmits information based on the response received from the settlement server 5 to the commodity data processing apparatus 2. For example, if the response indicating approval is received, the control section 22 transmits a message indicating that the settlement is completed to the commodity data processing apparatus 2. For example, if the response indicating disapproval is received, the control section 22 transmits a message indicating that the settlement fails to the commodity data processing apparatus 2. In this case, the commodity data processing apparatus 2 selects the settlement method again according to the operation.

Next, the wireless communication performed between the commodity data processing apparatus 2 and the settlement terminal 4 is described.

The wireless communication section 11 of the commodity data processing apparatus 2 and the wireless communication section 21 of the settlement terminal 4 each have an antenna, a modulation circuit, an oscillator, an amplifier and the like as a configuration of a transmission side.

When the wireless communication section 11 and the wireless communication section 21 output radio waves, respectively, the wireless communication section 11 and the wireless communication section 21 each generate a high frequency signal having a frequency corresponding to a transmission destination with the oscillator, modulate data (transmission data) to be transmitted by the high frequency signal, amplify the modulated signal with the amplifier, and finally supply the amplified signal to the antenna. As a result, the wireless communication section 11 and the wireless communication section 21 output radio waves corresponding to the transmission data from the antenna to the air.

The wireless communication section 11 of the commodity data processing apparatus 2 and the wireless communication section 21 of the settlement terminal 4 each have an antenna, a tuner, an amplifier, a demodulator, and the like as a configuration of the reception side.

When the wireless communication section 11 and the wireless communication section 21 receive radio waves, respectively, the wireless communication section 11 and the wireless communication section 21 each tune an electric signal converted from the radio waves by the antenna with the tuner, amplify the tuned electric signal with the amplifier, and demodulate the amplified electrical signal with the demodulator. As a result, the wireless communication section 11 and the wireless communication section 21 acquire the original transmission data.

In the above configuration, S/N varies depending on the intensity of the electrical signal generated by the antenna of the wireless communication section 21 of the settlement terminal 4. In order to efficiently perform wireless communication between the settlement terminal 4 and the commodity data processing apparatus 2, it is necessary to adjust a positional relationship between the settlement terminal 4 and the commodity data processing apparatus 2 while confirming the intensity of radio waves (radio field intensity) received by the wireless communication section 21 of the settlement terminal 4. Therefore, the settlement terminal 4 measures the radio field intensity used in the wireless communication and displays a radio field intensity display based on the measurement result on the display 24. The radio field intensity display shows the intensity of radio waves gradually and visually. In the settlement terminal 4, the radio field intensity display in a plurality of stages is preset.

The processor 26 executes the program stored in the memory 27, and in this way, the control section 22 of the settlement terminal 4 executes a radio field intensity display processing for displaying the radio field intensity display on the display 24. Specifically, the control section 22 functions as a radio field intensity display module for displaying the radio field intensity display indicating the radio field intensity on the display 24.

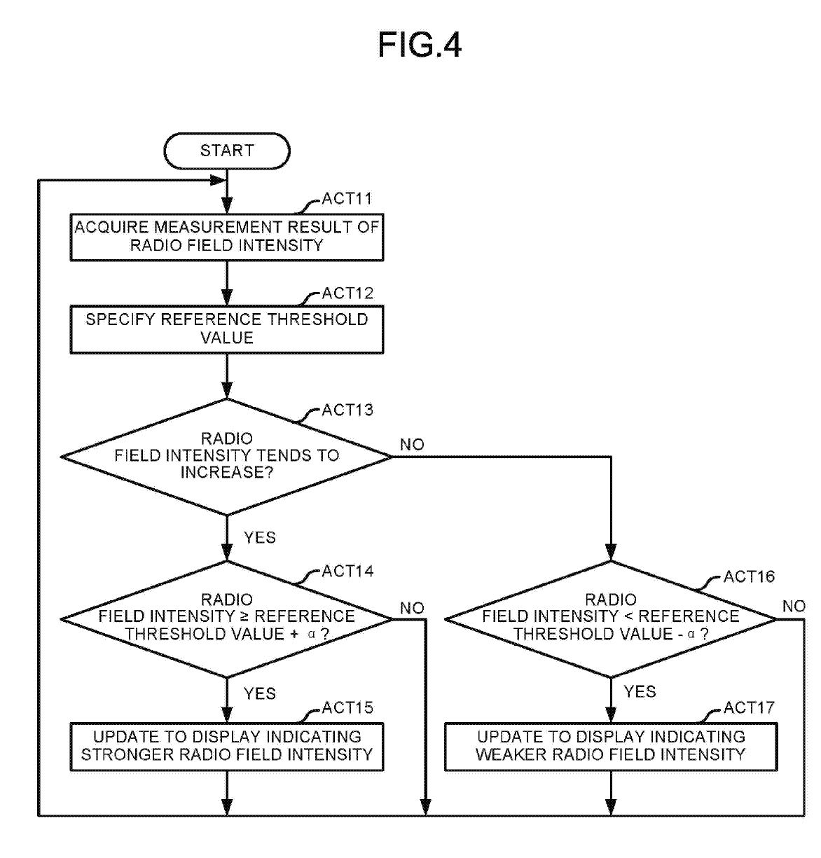

FIG. 4 is a flowchart depicting an example of the radio field intensity display processing executed by the control section 22 of the settlement terminal 4. The radio field intensity display is an initial display indicating that the radio field intensity is the weakest if the radio field intensity has not been measured yet.

First, the control section 22 measures the radio field intensity (ACT 11). For example, the control section 22 measures the radio field intensity [dB] based on the electrical signal generated by the antenna of the wireless communication section 21. Specifically, the control section 22 functions as a radio field intensity measurement module that measures the radio field intensity used in the wireless communication. The wireless communication section 21 may comprise a circuit for measuring the radio field intensity and supplying the measurement result to the control section 22.

The control section 22 changes the radio field intensity display based on the measurement result of the radio field intensity and a threshold value. For example, the control section 22 stores a reference threshold value which is a criterion for comparison with the radio field intensity, and a margin α in the memory 27 in advance. The reference threshold value is a preset value of the radio field intensity. The margin α is a preset value to be added or subtracted to or from the reference threshold value. A plurality of the reference threshold values may be stored in the memory 27. The plurality of the reference threshold values is associated with different radio field intensity display, respectively. The control section 22 may rewrite the reference threshold value and the margin α in the memory 27 based on information supplied from an external device.

If the radio field intensity is measured in the ACT 11, the control section 22 specifies the reference threshold value used for comparison with the radio field intensity among the reference threshold values stored in the memory 27 (ACT 12). For example, if a plurality of the reference threshold values is stored in the memory 27, the control section 22 specifies the reference threshold value closest to the radio field intensity measured in ACT 11. The control section 22 adds the above margin α to the specified reference threshold value to calculate a threshold value at the time of increase (reference threshold value+α). The control section 22 subtracts the above margin from the specified reference threshold value to calculate a threshold value (the reference threshold value −α) at the time of decrease.

The control section 22 determines whether the measurement result of the radio field intensity indicates that the radio field intensity tends to increase or decrease (ACT 13). For example, the control section 22 acquires the measurement result of the radio field intensity over a predetermined period of time to determine whether the radio field intensity tends to increase or decrease based on the change in the value of the radio field intensity. The control section 22 compares the measurement result of the radio field intensity of the previous time with the measurement result of the radio field intensity of the current time to determine whether the radio field intensity tends to increase or decrease based on whether a value of the radio field intensity increases.

If it is determined that the measurement result of the radio field intensity indicates that the radio field intensity tends to increase (Yes in ACT 13), the control section 22 determines whether or not the value of the radio field intensity is equal to or larger than the threshold value at the time of increase (ACT 14). Specifically, the control section 22 determines whether or not “the radio field intensity≥the reference threshold value+α” is satisfied.

If it is determined that the value of the radio field intensity is equal to or larger than the threshold value at the time of increase (Yes in ACT 14), the control section 22 updates the radio field intensity display displayed on the display 24 to a display indicating a stronger radio field intensity (ACT 15), and then proceeds to the processing in ACT 11. Specifically, the control section 22 updates the radio field intensity display to the radio field intensity display associated with the reference threshold value specified in ACT 12. If it is determined that the value of the radio field intensity is less than the threshold value at the time of increase (No in ACT 14), the control section 22 proceeds to the processing in ACT 11.

If it is determined that the measurement result of the radio field intensity that indicates the radio field intensity tends to decrease (No in ACT 13), the control section 22 determines whether or not the value of the radio field intensity is less than the threshold value at the time of decrease (ACT 16). Specifically, the control section 22 determines whether or not “the radio field intensity <the reference threshold value−α” is satisfied.

If it is determined that the value of the radio field intensity is less than the threshold value at the time of decrease (Yes in ACT 16), the control section 22 updates the radio field intensity display displayed on the display 24 to the display indicating the weaker radio field intensity (ACT 17), and then proceeds to the processing in ACT 11. Specifically, the control section 22 updates the radio field intensity display to the radio field intensity display associated to the reference threshold value that is one stage lower than the reference threshold value specified in the ACT 12. If it is determined that the value of the radio field intensity is equal to or larger than the threshold value at the time of decrease (No in ACT 16), the control section 22 proceeds to the processing in ACT 11.

The control section 22 successively updates the radio field intensity display displayed on the display 24 by repeatedly executing the processing shown in FIG. 4 in the same as described above. The control section 22 may proceed to the processing in ACT 11 if a predetermined time elapses at the time of proceeding to the processing in ACT 11 from ACT 14 to ACT 17. As a result, the control section 22 can reduce an update frequency of the radio field intensity display displayed on the display 24.

The control section 22 updates the radio field intensity display to the radio field intensity display associated with the reference threshold value if the radio field intensity tends to increase and the radio field intensity is equal to or larger than the threshold value at the time of increase obtained by adding the margin to the reference threshold value. If the radio field intensity tends to decrease and the radio field intensity is less than the threshold value at the time of decrease obtained by subtracting the margin from the reference threshold value, the control section 22 updates the radio field intensity display to the radio field intensity display associated to the reference threshold value that is one stage lower than the reference threshold value used for comparison with the radio field intensity. Specifically, the control section 22 functions as a display control module for updating the radio field intensity display based on the measurement result of the radio field intensity.

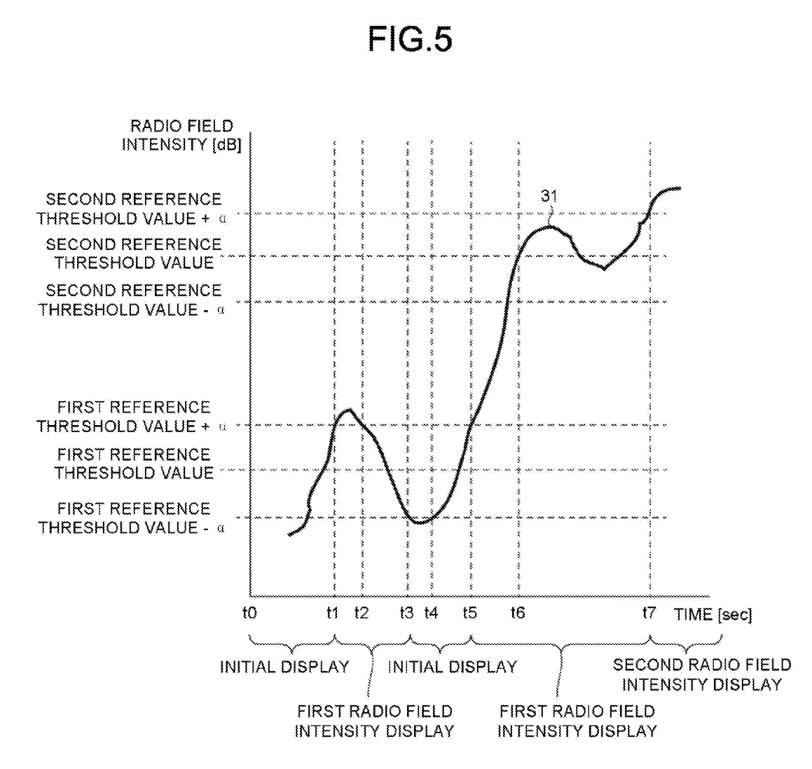

FIG. 5 is a diagram illustrating the radio field intensity and the transition of the radio field intensity display. A vertical axis in FIG. 5 shows the radio field intensity. A horizontal axis in FIG. 5 shows the time. A graph 31 shows a change in the measurement result of the radio field intensity at each time point. In this example, a first reference threshold value and a second reference threshold value are set as the reference threshold value. In the following description, it is assumed that a first radio field intensity display is associated with the first reference threshold value, and a second radio field intensity display is associated with the second reference threshold value.

As shown in FIG. 5, at a timing t0, the radio field intensity display is an initial display indicating that the radio field intensity is the weakest.

At a timing t1, the radio field intensity increases and the radio field intensity becomes equal to or larger than “the first reference threshold value+α” obtained by adding the margin α to the first reference threshold value. In this case, the control section 22 updates the radio field intensity display from the initial display to the first radio field intensity display associated with the first reference threshold value.

Next, at a timing t2, the radio field intensity becomes less than “the first reference threshold value+α”. In this case, the control section 22 maintains the first radio field intensity display since the radio field intensity is not less than “the first reference threshold value−αa”.

At a timing t3, the radio field intensity becomes less than “the first reference threshold value−α”. In this case, the control section 22 updates the radio field intensity display to the radio field intensity display associated with the reference threshold value that is one stage lower than the reference threshold value used for comparison with the radio field intensity. The control section 22 updates the radio field intensity display to the initial display from the first radio field intensity display if the reference threshold value used for comparison with the radio field intensity is the lowest reference threshold value.

Next, at a timing t4, the radio field intensity becomes equal to or larger than “the first reference threshold value−α”. In this case, since the radio field intensity is not equal to or larger than “the first reference threshold value+α”, the control section 22 maintains the initial display.

At a timing t5, the radio field intensity becomes equal to or larger than “the first reference threshold value+α”. In this case, the control section 22 updates the radio field intensity display from the initial display to the first radio field intensity display associated with the first reference threshold value.

At a timing t6, the radio field intensity is equal to or larger than “the second reference threshold value” and less than “the second reference threshold value+α”. In this case, the control section 22 maintains the first radio field intensity display since the radio field intensity is not equal to or larger than “the second reference threshold value+α”.

At a timing t7, the radio field intensity becomes equal to or larger than “the second reference threshold value+α”. In this case, the control section 22 updates the radio field intensity display to the second radio field intensity display associated with the second reference threshold value from the first radio field intensity display.

As described above, the settlement terminal 4 includes the memory 27 in which the reference threshold value and the margin (any value) are stored in advance, the processor 26, and the display 24. The processor 26 measures the radio field intensity used in the wireless communication with the external device; compares the measurement result of the radio field intensity with the reference threshold value; and displays the display indicating a stronger radio field intensity on the display 24 if the radio field intensity tends to increase and the radio field intensity is equal to or larger than the threshold value at the time of increase obtained by adding the margin to the reference threshold value, or displays the display indicating the weaker radio field intensity on the display 24 if the radio field intensity tends to decrease and the radio field intensity is less than the threshold value at the time of decrease obtained by subtracting the margin from the reference threshold value. Thus, even if the measurement result of the radio field intensity changes around the reference threshold value, the radio field intensity display can be prevented from being frequently updated, and the timeliness of the update of the radio field intensity display based on the measurement result of the radio field intensity can be ensured. As a result, the processing load of the processor 26 of the settlement terminal 4 can be reduced.

In the above embodiment, the settlement terminal 4 communicates with the settlement server 5 via the commodity data processing apparatus 2, but it is not limited thereto. The settlement terminal 4 may directly communicate with the settlement server 5 using signal lines in the commodity data processing apparatus 2.

In the above embodiment, the settlement terminal 4 reads the card information from the credit card and transmits the settlement request to the settlement server 5, but it is not limited thereto. The settlement terminal 4 may process any card such as a debit card, a prepaid card, a non-contact IC (integrated circuit) card, a point card or the like.

The settlement terminal 4 includes the wireless communication section 21 as an interface for communicating with the commodity data processing apparatus 2; however, it is not limited thereto. Instead of the wireless communication section 21, the settlement terminal 4 may have an interface through which a wireless communication device can be mounted. According to such a configuration, the settlement terminal 4 can use an SD (synchronous dynamic) card functioning as the wireless communication device connected to the interface instead of the wireless communication section 21.

The control section 22 of the settlement terminal 4 stores the reference threshold value serving as a criterion for comparison with the radio field intensity and the margin α in the memory 27 in advance; however, it is not limited thereto. The control section 22 may store a threshold value corresponding to each change of the stage of the radio field intensity display in the memory 27. For example, if the radio field intensity display includes the initial display, the first radio field intensity display, and the second radio field intensity display, the control section 22 may store a first threshold value corresponding to a change from the initial display to the first radio field intensity display, a second threshold value corresponding to a change from the first radio field intensity display to the initial display, a third threshold value corresponding to a change from the first radio field intensity display to the second radio field intensity display, a fourth threshold value corresponding to a change from the second radio field intensity display to the first radio field intensity display. The first threshold value is larger than the second threshold value, the fourth threshold value is larger than the first threshold value, and the third threshold value is larger than the fourth threshold value.

In this case, the control section 22 updates the radio field intensity display from the initial display to the first radio field intensity display when the radio field intensity exceeds the first threshold value. The control section 22 updates the radio field intensity display from the first radio field intensity display to the initial display when the radio field intensity is less than the second threshold value. The control section 22 updates the radio field intensity display from the first radio field intensity display to the second radio field intensity display when the radio field intensity exceeds the third threshold value. The control section 22 updates the radio field intensity display from the second radio field intensity display to the first radio field intensity display when the radio field intensity is less than the fourth threshold value. With such a configuration, the control section 22 of the settlement terminal 4 can also prevent the radio field intensity display from being updated frequently, while the timeliness of the update of the radio field intensity display based on the measurement result of the radio field intensity can be ensured.

While certain embodiments have been described, these embodiments have been presented by way of examples only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An information processing apparatus, comprising:
a wireless communication module configured to establish wireless communication with an external device;
a radio field intensity measurement module configured to measure a radio field intensity used in the wireless communication;
a radio field intensity display module configured to display a radio field intensity display indicating the radio field intensity; and
a display control module configured to determine whether the radio field intensity tends to increase or decrease based on a measurement result of the radio field intensity by the radio field intensity measurement module, and to update the radio field intensity display to a display indicating a stronger radio field intensity if the radio field intensity tends to increase and the radio field intensity is equal to or larger than a first threshold value, or to update the radio field intensity display to a display indicating a weaker radio field intensity if the radio field intensity tends to decrease and the radio field intensity is less than a second threshold value smaller than the first threshold value.

2. The information processing apparatus according to claim 1, wherein
the first threshold value is obtained by adding a predetermined value to a preset reference threshold value, and the second threshold value is obtained by subtracting the predetermined value from the reference threshold value.

3. The information processing apparatus according to claim 2, wherein
the information processing apparatus comprises a plurality of reference threshold values, and
the display control module specifies a reference threshold value closest to the current radio field intensity among the plurality of reference threshold values.

4. The information processing apparatus according to claim 3, further comprising:
a card reading module configured to read card information from a card possessed by a customer; and
a settlement processing module configured to acquire a settlement amount of a commodity from a commodity data processing apparatus which is the external device to which data of the commodity purchased by a customer is input, and to perform a settlement processing based on the settlement amount and the card information, wherein
a processor functioning as the display control module has lower processing performance than a processor of the external device.

5. The information processing apparatus according to claim 1, wherein
the information processing apparatus is a POS terminal.

6. The information processing apparatus according to claim 1, wherein
the external device is a POS server.

7. The information processing apparatus according to claim 1, wherein
the radio field intensity display displays the radio field intensity in a graphical manner.

8. The information processing apparatus according to claim 1, wherein
the radio field intensity measurement module measures radio field intensity based on an electrical signal generated by an antenna of the wireless communication module.

9. A control method by an information processing apparatus having a wireless communication module which establishes wireless communication with an external device, comprising:
measuring a radio field intensity used in the wireless communication;
displaying a radio field intensity display indicating the radio field intensity;
determining whether the radio field intensity tends to increase or decrease based on the measurement result of the radio field intensity;
updating the radio field intensity display to a display indicating a stronger radio field intensity if the radio field intensity tends to increase and the radio field intensity is equal to or larger than a first threshold value; and
updating the radio field intensity display to a display indicating a weaker radio field intensity if the radio field intensity tends to decrease and the radio field intensity is less than a second threshold value smaller than the first threshold value.

10. The control method according to claim 9, further comprising:
obtaining the first threshold value by adding a predetermined value to a preset reference threshold value, and
obtaining the second threshold value by subtracting the predetermined value from the reference threshold value.

11. The control method according to claim 10, wherein
the information processing apparatus comprises a plurality of reference threshold values, further comprising:
specifying a reference threshold value closest to the current radio field intensity among the plurality of reference threshold values.

12. The control method according to claim 11, further comprising:
reading card information from a card possessed by a customer; and
acquiring a settlement amount of a commodity from a commodity data processing apparatus which is the external device to which data of the commodity purchased by a customer is input, and performing a settlement processing based on the settlement amount and the card information, wherein
a processor functioning as the display control module has lower processing performance than a processor of the external device.

13. The control method according to claim 9, wherein
the information processing apparatus is a POS terminal.

14. The control method according to claim 9, wherein
the external device is a POS server.

15. The control method according to claim 9, further comprising:
displaying the radio field intensity in a graphical manner.

16. The control method according to claim 9, further comprising:
measuring radio field intensity based on an electrical signal generated by an antenna of the wireless communication module.
